(19) United States
(12) Patent Application Publication
(10) Pub. No.: US 2022/0345376 A1
(43) Pub. Date: Oct. 27, 2022

(54) SYSTEM, METHOD, AND CONTROL APPARATUS

(71) Applicant: NEC Corporation, Minato-ku, Tokyo (JP)

(72) Inventors: Anan SAWABE, Tokyo (JP); Takanori IWAI, Tokyo (JP)

(73) Assignee: NEC Corporation, Minato-ku, Tokyo (JP)

(21) Appl. No.: 17/641,178

(22) PCT Filed: Sep. 30, 2019
(86) PCT No.: PCT/JP2019/038459

§ 371 Date: Mar. 8, 2022

(51) Int. Cl. H04L 41/16; H04L 41/0813

(52) U.S. Cl. CPC H04L 41/16; H04L 41/0813

(57) ABSTRACT

In order to enable communication control to promptly comply with a communication environment, a system according to an aspect of the present disclosure includes: a first adjusting means for adjusting a parameter for controlling communication in a communication network by using a parameter determining method; and a second adjusting means for adjusting the parameter by using reinforcement learning, after adjusting the parameter using the parameter determining method.

### BACKGROUND

### Technical Field

The present disclosure relates to a system, a method, and a control apparatus.

### Background Art

In a network in which a communication environment changes, automatically configuring a control parameter suitable for the communication environment is extremely important. As a method for automatically configuring the control parameter, machine learning is expected. As a type of the machine learning, reinforcement learning has been known.

For example, PTL 1 describes a technique of performing control by using reinforcement learning.

### CITATION LIST

### Patent Literature

PTL 1: JP 2019-053589 A

### SUMMARY

### Technical Problem

In order to adjust a parameter for controlling communication in a communication network, reinforcement learning may be used. However, when the parameter significantly deviates from a value optimal for a state of the communication network, a long period of time may be required to cause the parameter to get closer to the optimal value using reinforcement learning with exploration. Thus, control of communication in the communication network may not be suitable for the state of the communication network over a long period of time. In other words, it may be difficult for communication control to comply with a communication environment.

An example object of the present invention is to provide a system, a method, and a control apparatus that enable communication control to promptly comply with a communication environment.

### Solution to Problem

A system according to an aspect of the present disclosure includes: a first adjusting means for adjusting a parameter for controlling communication in a communication network by using a parameter determining method; and a second adjusting means for adjusting the parameter by using reinforcement learning, after adjusting the parameter using the parameter determining method.

A method according to an aspect of the present disclosure includes: adjusting a parameter for controlling communication in a communication network by using a parameter determining method; and adjusting the parameter by using reinforcement learning after adjusting the parameter using the parameter determining method.

A control apparatus according to an aspect of the present disclosure includes: a first adjusting means for adjusting a parameter for controlling communication in communication network, using a parameter determining method; and a second adjusting means for adjusting the parameter using reinforcement learning, after adjusting the parameter using the parameter determining method.

### Advantageous Effects of Invention

According to the present invention, communication control can be caused to promptly comply with a communication environment. Note that, according to the present invention, instead of or together with the above effects, other effects may be exerted.

### BRIEF DESCRIPTION OF THE DRAWINGS

FIG. 1 is a diagram for illustrating an overview of reinforcement learning;

FIG. 2 is a diagram for illustrating an example of a Q table;

FIG. 3 is a diagram illustrating an example of a schematic configuration of a system according to a first example embodiment;

FIG. 4 is a block diagram illustrating an example of a schematic functional configuration of a control apparatus according to the first example embodiment;

FIG. 5 is a block diagram illustrating an example of a schematic hardware configuration of the control apparatus according to the first example embodiment;

FIG. 6 is a flowchart for illustrating an example of a general flow of parameter adjustment processing according to the first example embodiment;

FIG. 7 is a flowchart for illustrating an example of a general flow of parameter adjustment processing according to a third example alteration of the first example embodiment;

FIG. 8 is a flowchart for illustrating an example of a general flow of parameter adjustment processing according to a fourth example alteration of the first example embodiment;

FIG. 9 is a diagram for illustrating an example of operation of the control apparatus according to the first example embodiment;

FIG. 10 is a diagram for illustrating a first example of the operation of the control apparatus according to a fifth example alteration of the first example embodiment;

FIG. 11 is a diagram for illustrating a second example of the operation of the control apparatus according to the fifth example alteration of the first example embodiment;

FIG. 12 is a diagram for illustrating a third example of the operation of the control apparatus according to the fifth example alteration of the first example embodiment;

FIG. 13 is a diagram illustrating an example of a schematic configuration of a system according to a second example embodiment; and

FIG. 14 is a flowchart for illustrating an example of a general flow of parameter adjustment processing according to the second example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same reference signs, and overlapping descriptions may hence be omitted.

Descriptions will be given in the following order.

1. Related Art

2. First Example Embodiment
2.1. Configuration of System
2.2. Configuration of Control Apparatus
2.3. Operation (Adjustment of Parameter)
2.4. Example Alterations

3. Second Example Embodiment

### 1. Related Art

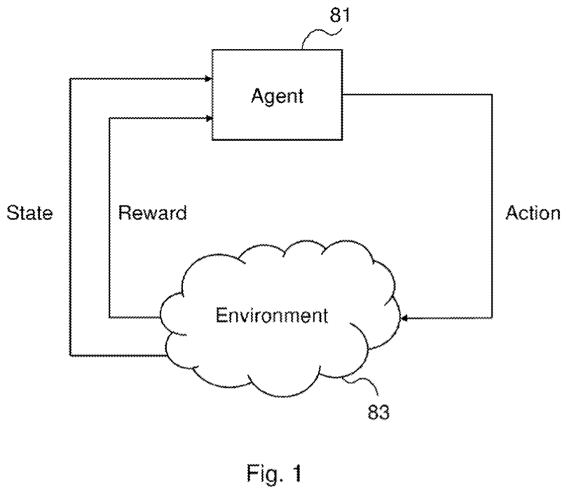

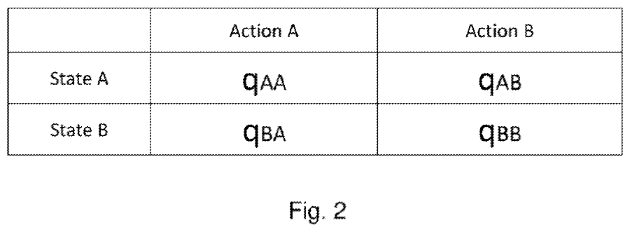

With reference to FIG. 1 and FIG. 2, reinforcement learning will be described as a technique related to an example embodiment of the present disclosure.

FIG. 1 is a diagram for illustrating an overview of reinforcement learning. With reference to FIG. 1, in reinforcement learning, an agent 81 observes a state of an environment 83, and selects an action from the observe state. The agent 81 obtains a reward from the environment 83 through selection of the action under the environment. Through repetition of such a series of operations, the agent 81 can learn what kind of action brings out the greatest reward according to the state of the environment 83. In other words, the agent 81 can learn an action to be selected according to the environment in order to maximize the reward.

An example of reinforcement learning is Q learning. In Q learning, for example, a Q table is used, which indicates how high value each action has regarding each state of the environment 83. The agent 81 selects an action according to a state of the environment 83 by using the Q table. In addition, the agent 81 updates the Q table, based on the reward obtained according to selection of the action.

FIG. 2 is a diagram for illustrating an example of the Q table. With reference to FIG. 2, the states of the environment 83 include state A and state B, and the actions of the agent 81 include action A and action B. The Q table indicates value when each action is taken in each state. For example, the value of taking action A in state A is q_{AA}, and the value of taking action B in state A is q_{AB}. The value of taking action A in state B is q_{BA}, and the value of taking action B in state B is q_{BB}. For example, the agent 81 takes an action having the highest value in each state. As an example, when q_{AA} is higher than q_{AB}, the agent 81 takes action A in state A. Note that the value (q_{AA}, q_{AB}, q_{BA}, and q_{BB}) in the Q table is updated based on the reward obtained according to selection of the action.

In reinforcement learning, taking an action having the highest value in each state described above is referred to as “exploitation (use)”. When learning is performed only by “exploitation”, learning results may be a local optimal solution instead of an optimal solution because the action that can be taken in each state is limited. Thus, in reinforcement learning, learning is performed by “exploitation” and “exploration (search)”. “Exploration” means that an action randomly selected in each state is taken. For example, in the Epsilon-Greedy method, “exploration” is selected with probability ε, and “exploitation” is selected with probability 1−ε. With “exploration”, for example, in a certain state, an action with unknown value is selected, and as a result, value of the action in the certain state can be known. Owing to such “exploration”, it is more likely that an optimal solution may be obtained as the learning results.

### 2. First Example Embodiment

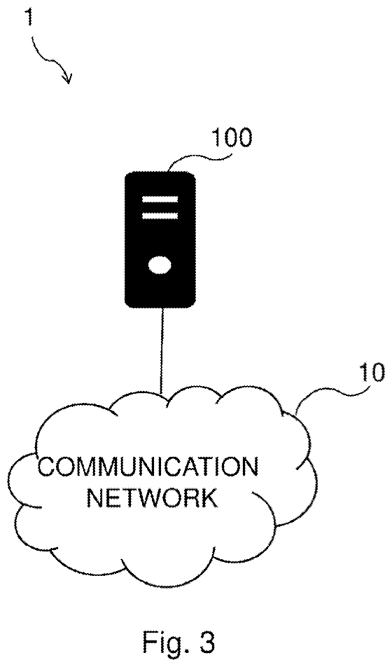

With reference to FIG. 3 to FIG. 12, a first example embodiment of the present disclosure will be described.

<2.1. Configuration of System>

FIG. 3 illustrates an example of a schematic configuration of a system 1 according to the first example embodiment. With reference to FIG. 3, the system 1 includes a communication network 10 and a control apparatus 100.

(1) Communication Network 10

The communication network 10 transfers data. For example, the communication network 10 includes network devices (for example, a proxy server, a gateway, a router, a switch, and/or the like) and a line, and each of the network devices transfers data via the line.

The communication network 10 may be a wired network, or may be a radio network. Alternatively, the communication network 10 may include both of a wired network and a radio network. For example, the radio network may be a mobile communication network using the standard of a communication line such as Long Term Evolution (LTE) or 5th Generation (5G), or may be a network used in a specific area such as a wireless local area network (LAN) or a local 5G. The wired network may be, for example, a local area network (LAN), a wide area network (WAN), the Internet, or the like.

(2) Control Apparatus 100

The control apparatus 100 performs control for the communication network 10.

For example, the control apparatus 100 adjusts a parameter for controlling communication in the communication network 10.

For example, the control apparatus 100 is a network device (for example, a proxy server, a gateway, a router, a switch, and/or the like) that transfers data in the communication network 10.

Note that the control apparatus 100 according to the first example embodiment is not limited to the network device that transfers data in the communication network 10. This will be described later in detail as a fifth example alteration of the first example embodiment.

<2.2. Configuration of Control Apparatus>

(1) Functional Configuration

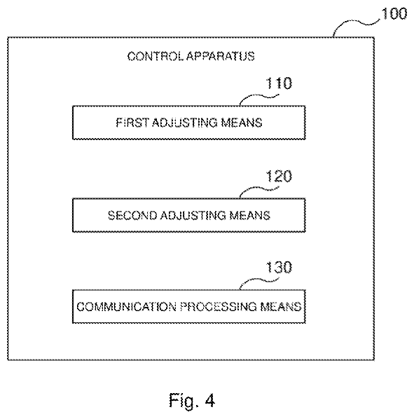

FIG. 4 is a block diagram illustrating an example of a schematic functional configuration of the control apparatus 100 according to the first example embodiment. With reference to FIG. 4, the control apparatus 100 includes a first adjusting means 110, a second adjusting means 120, and a communication processing means 130.

The operation of each of the first adjusting means 110, the second adjusting means 120, and the communication processing means 130 will be described later.

(2) Hardware Configuration

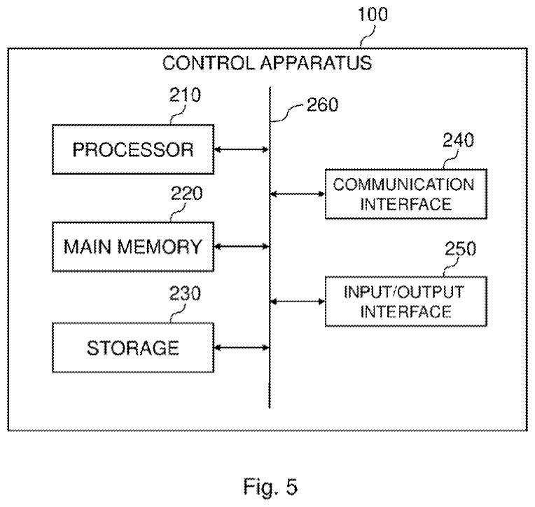

FIG. 5 is a block diagram illustrating an example of a schematic hardware configuration of the control apparatus 100 according to the first example embodiment. With reference to FIG. 5, the control apparatus 100 includes a processor 210, a main memory 220, a storage 230, a communication interface 240, and an input/output interface 250. The processor 210, the main memory 220, the storage 230, the communication interface 240, and the input/output interface 250 are connected to each other via a bus 260.

The processor 210 executes a program read from the main memory 220. As an example, the processor 210 is a central processing unit (CPU).

The main memory 220 stores a program and various pieces of data. As an example, the main memory 220 is a random access memory (RAM).

The storage 230 stores a program and various pieces of data. As an example, the storage 230 includes a solid state drive (SSD) and/or a hard disk drive (HDD).

The communication interface 240 is an interface for communication with another apparatus. As an example, the communication interface 240 is a network adapter or a network interface card.

The input/output interface 250 is an interface for connection with an input apparatus such as a keyboard, and an output apparatus such as a display.

Each of the first adjusting means 110, the second adjusting means 120, and the communication processing means 130 may be implemented with the processor 210 and the main memory 220, or may be implemented with the processor 210, the main memory 220, and the communication interface 240.

As a matter of course, the hardware configuration of the control apparatus 100 is not limited to the example described above. The control apparatus 100 may be implemented with another hardware configuration.

Alternatively, the control apparatus 100 may be virtualized. In other words, the control apparatus 100 may be implemented as a virtual machine. In this case, the control apparatus 100 (virtual machine) may operate as a physical machine (hardware) including a processor, a memory, and the like, and a virtual machine on a hypervisor. As a matter of course, the control apparatus 100 (virtual machine) may be distributed into a plurality of physical machines for operation.

The control apparatus 100 may include a memory (main memory 220) that stores a program (instructions), and one or more processors (processors 210) that can execute the program (instructions). The one or more processors may execute the program to perform the operations of the first adjusting means 110, the second adjusting means 120, and/or the communication processing means 130. The program may be a program for causing the processor(s) to execute the operations of the first adjusting means 110, the second adjusting means 120, and/or the communication processing means 130.

<2.3. Operation (Adjustment of Parameter)>

The control apparatus 100 (first adjusting means 110) adjusts a parameter (hereinafter referred to as “network control parameter”) for controlling communication in the communication network 10 by using a parameter determining method. The control apparatus 100 (second adjusting means 120) adjusts the network control parameter by using reinforcement learning.

In particular, in the first example embodiment, the control apparatus 100 (second adjusting means 120) adjusts the network control parameter by using the reinforcement learning after adjusting the parameter using the parameter determining method.

(1) Network Control Parameter

As described above, for example, the control apparatus 100 is a network device (for example, a proxy server, a gateway, a router, a switch, and/or the like) that transfers data in the communication network 10. In this case, the network control parameter is, for example, a parameter configured in the control apparatus 100, and the control apparatus 100 (communication processing means 130) transfers data (for example, packets) according to the network control parameter.

The network control parameter is, for example, a parameter for controlling a specific flow in the communication network 10. In other words, the network control parameter is a parameter for each flow. As an example, the specific flow may be a specific flow for video traffic. A flow corresponding to a packet is, for example, identified from a transmission address, a reception address, and a port number of the packet.

As an example, the network control parameter is an upper limit of throughput.

Note that, as a matter of course, the network control parameter according to the first example embodiment is not limited to the example described above. This will be described later in detail as a first example alteration of the first example embodiment.

(2) Reinforcement Learning

As described above, the control apparatus 100 (second adjusting means 120) adjusts the network control parameter by using reinforcement learning.

State, Action, and Reward

For example, the control apparatus 100 (second adjusting means 120) adjusts the network control parameter, based on a state (hereinafter referred to as a “network state”) of the communication network 10 by using the reinforcement learning, for example.

For example, in the reinforcement learning, the control apparatus 100 (second adjusting means 120) applies the network state as a state of an environment and applies a change of the network control parameter as an action selected according to the state of the environment, and thereby adjusts the network control parameter by using the reinforcement learning. In other words, the control apparatus 100 (second adjusting means 120) selects a change (in other words, the action) of the network control parameter from the network state (in other words, the state) by using the reinforcement learning, and thereby adjusts the network control parameter.

As described above, the network control parameter is, for example, a parameter for controlling a specific flow in the communication network 10. In this case, the network state is, for example, the state of the communication network 10 regarding the specific flow. As an example, the specific flow may be a specific flow for video traffic.

As described above, as an example, the network control parameter is an upper limit of throughput. In contrast, as an example, the network state is quality of experience (QoE) of a video. Specifically, the QoE may be a bit rate of a video, or may be resolution of a video.

As a matter of course, the network state according to the first example embodiment is not limited to the examples described above. This will be described later in detail as a first example alteration of the first example embodiment.

A reward in the reinforcement learning is, as an example, QoE of a video similarly to the network state. As a matter of course, the reward according to the first example embodiment is not limited to the example described above either.

Note that, although the network state is the state of the communication network 10, it can also be said that the network state is a state of communication in the communication network 10.

Exploration and Exploitation

In addition, for example, in the reinforcement learning, the control apparatus 100 (second adjusting means 120) selects a random change of the network control parameter as exploration and selects an optimal change of the network control parameter in terms of learning results as exploitation, and thereby adjusts the network control parameter.

For example, in the reinforcement learning, the control apparatus 100 (second adjusting means 120) selects a random change of the network control parameter with probability ε, and selects an optimal change of the network control parameter in terms of learning results with probability 1−ε.

Adjustment of Network Control Parameter

For example, the control apparatus 100 (second adjusting means 120) selects a change of the network control parameter from the network state by using the reinforcement learning. Then, the control apparatus 100 (second adjusting means 120) configures the changed value of the network control parameter. The control apparatus 100 (second adjusting means 120) repeats such selection and configuration as described above, for example, and thereby adjusts the network control parameter.

(3) Parameter Determining Method

As described above, the control apparatus 100 (first adjusting means 110) adjusts the network control parameter by using the parameter determining method.

Without Random Determination

As described above, for example, in the reinforcement learning, the control apparatus 100 (second adjusting means 120) selects a random change of the network control parameter as exploration. In contrast, the control apparatus 100 (first adjusting means 110) adjusts the network control parameter without randomly determining the network control parameter in the parameter determining method.

Gradient Method

For example, the parameter determining method is a gradient method. For example, the control apparatus 100 (first adjusting means 110) iteratively determines the network control parameter by using the gradient method, and thereby adjusts the network control parameter.

For example, in order to find a value of the network control parameter that minimizes a difference between a target value and an actual value of a reward for determination of the network control parameter, the control apparatus 100 (first adjusting means 110) iteratively determines the network control parameter by using the gradient method. In this manner, the control apparatus 100 (first adjusting means 110) adjusts the network control parameter.

The reward is, for example, the same as a reward in the reinforcement learning. As described above, as an example, the reward is QoE (for example, a bit rate, resolution, or the like) of a video.

For example, the network control parameter is determined and is then configured, and as a result, the actual value of the reward is obtained. Then, a difference between the target value and the actual value of the reward is calculated. In addition, the gradient of the difference for the network control parameter (in other words, the rate of an increase amount of the difference to an increase amount of the network control parameter) is calculated. Next, based on the gradient, the network control parameter is increased or decreased so that the difference becomes smaller. In this manner, the network control parameter is determined again, and is then configured. The operation as described above is iteratively performed, and the network control parameter changes so as to get closer to a value that minimizes the difference. Note that the increase or the decrease of the network control parameter is performed based on the gradient, and is not randomly performed. The amount of increase or decrease of the network control parameter may be a predetermined amount, or may be an amount according to the gradient (for example, a larger amount if the gradient is larger, and a smaller amount if the gradient is smaller).

More specifically, adjustment of the network control using the gradient method will be described. For example, the value of the network control parameter may be represented by x, and the difference between the target value and the actual value (for example, target QoE—actual QoE) of the reward may be represented by y. The target value of the reward may be a value determined in advance, and the actual value of the reward may be obtained according to determination of the network control parameter, and thus y being the difference can be considered as a function of x, and can be expressed as f(x), for example. For example, in such a case, in order to find x that minimizes y (=f(x)), x is iteratively determined by using the gradient method. Specifically, for example, xᵢ (i-th x) is determined and is then configured, and as a result, the actual value of the reward is obtained. Then, yᵢ (i-th y) being the difference between the target QoE and the actual QoE is calculated. In addition, the gradient aᵢ of y (in other words, f(x)) for x is calculated. Because the content of f(x) is unknown, the gradient aᵢ may be, for example, simply calculated according to (yᵢ−yᵢ₋₁)/(xᵢ−xᵢ₋₁). Next, xᵢ₊₁ is obtained by adding or subtracting b (positive value) to or from xᵢ so that yᵢ₊₁ {(i+1)-th y} becomes smaller based on the gradient aᵢ. b may be a predetermined amount, or may be an amount according to aᵢ. For example, if aᵢ is a positive value, xᵢ₊₁=xᵢ−b, and if aᵢ is a negative value, xᵢ₊₁=xᵢ+b. In this manner, xᵢ₊₁ is determined and is then configured. As described above, x is iteratively determined, and x changes so as to get closer to a value that minimizes y. Note that increase or decrease of x is performed based on aᵢ, and is not randomly performed.

Adjustment of Network Control Parameter

For example, the control apparatus 100 (first adjusting means 110) determines the network control parameter by using the parameter determining method. Then, the control apparatus 100 (first adjusting means 110) configures the determined value of the network control parameter. The control apparatus 100 (second adjusting means 120) repeats such determination and configuration as described above, for example, and thereby adjusts the network control parameter.

Condition of Ending

For example, when the difference between the target value and the actual value of the reward is less than a predetermined threshold, the control apparatus 100 (first adjusting means 110) ends adjustment of the network control parameter using the parameter determining method. In this manner, for example, unnecessary iteration of parameter determination can be avoided.

For example, even if the difference is not less than the predetermined threshold, when the number of times of determination of the network control parameter reaches a predetermined number of times, the control apparatus 100 (first adjusting means 110) ends adjustment of the network control parameter using the parameter determining method. In this manner, for example, considerable iteration of parameter determination can be avoided.

When adjustment of the network control parameter using the parameter determining method ends, the control apparatus 100 (second adjusting means 120) adjusts the network control parameter by using the reinforcement learning.

By using the parameter determining method before the reinforcement learning as described above, even if the network control parameter significantly deviates from the value optimal for the network state, the network control parameter can be caused to further promptly get closer to the optimal value. Thus, communication control can promptly comply with the communication environment.

(4) Condition of Operation

For example, when a predetermined condition regarding a change of the state of the communication network 10 is satisfied, the control apparatus 100 (first adjusting means 110) adjusts the network control parameter by using the parameter determining method. Then, the control apparatus 100 (second adjusting means 120) adjusts the network control parameter by using the reinforcement learning after adjusting the network control parameter using the parameter determining method.

The state of the communication network 10 is a network state applied as the state of the environment in the reinforcement learning. As described above, as an example, the network state is QoE (for example, a bit rate or resolution) of a video.

For example, the predetermined condition regarding a change of the network state is that a change amount of the network state in a certain time period exceeds a predetermined threshold. In other words, when the change amount of the network state in the certain time period exceeds the predetermined threshold, the network control parameter is adjusted by using the parameter determining method, and subsequently, the network control parameter is adjusted by using the reinforcement learning.

As an example, regarding a flow of video traffic, when the change amount of QoE (for example, a bit rate or resolution) of a video exceeds the predetermined threshold, the upper limit of throughput regarding the flow is adjusted by using the parameter determining method. Subsequently, the upper limit of throughput regarding the flow is further adjusted by using the reinforcement learning.

In this manner, for example, even when the network control parameter significantly deviates from the value optimal for the network state as a result of a sudden change of the network state, the network control parameter can be caused to further promptly get closer to the optimal value.

Note that, for example, at the time of start of adjustment of the network control parameter as well, the network control parameter is adjusted by using the parameter determining method, and subsequently, the network control parameter is adjusted by using the reinforcement learning. In this manner, for example, even when an initial value of the network control parameter significantly deviates from the value optimal for the network state, the network control parameter can be caused to further promptly get closer to the optimal value.

(5) Flow of Processing

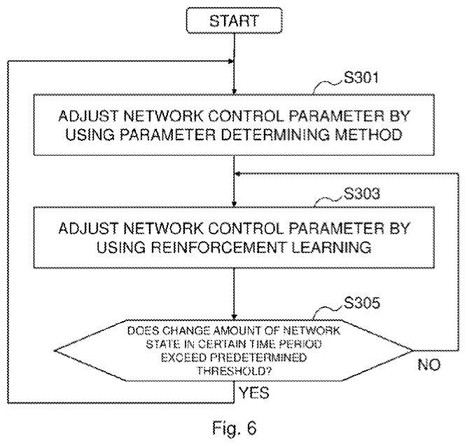

FIG. 6 is a flowchart for illustrating an example of a general flow of parameter adjustment processing according to the first example embodiment.

The control apparatus 100 (first adjusting means 110) adjusts the network control parameter by using the parameter determining method (specifically, the gradient method) (S301).

The control apparatus 100 (second adjusting means 120) adjusts the network control parameter by using reinforcement learning (S303).

When the change amount of the network state in a certain time period exceeds a predetermined threshold (S305—Yes), the control apparatus 100 (first adjusting means 110) adjusts the network control parameter by using the parameter determining method (specifically, the gradient method) (S301).

When the change amount does not exceed the predetermined threshold (S305—NO), the control apparatus 100 (first adjusting means 110) continues to adjust the network control parameter by using the reinforcement learning (S303).

<2.4. Example Alterations>

First to sixth example alterations of the first example embodiment will be described. Note that two or more example alterations of the first to sixth example alterations of the first example embodiment may be combined.

(1) First Example Alteration

As described above, the network control parameter is, for example, a parameter for controlling a specific flow in the communication network 10, and the network state is, for example, the state of the communication network 10 regarding the specific flow. As an example, the specific flow may be a specific flow for video traffic. In addition, as an example, the network control parameter is the upper limit of throughput, and the network state is QoE (for example, a bit rate or resolution) of a video. However, as a matter of course, the network control parameter and the network state according to the first example embodiment are not limited to the example described above.

In the first example alteration of the first example embodiment, first, the network control parameter need not be a parameter for each flow, and the network state need not be a network state for each flow either. The network control parameter may be a parameter regarding the entire communication that may include a plurality of flows, and the network state may also be a network state regarding the entire communication.

The network control parameter need not be the upper limit of throughput, and the network state need not be QoE of a video. A combination of the network state (NW state) and the network control parameter (NW control parameter) may be as follows:

### Example 1 (Example of Control of Transmission Control Protocol (TCP) Flow)

[NW State] Number of active flows, available band and/or,
Previous buffer size of Internet Protocol (IP)

[NW Control Parameter] Transmission buffer size

### Example 2 (Example of Robot Control)

[NW State] Packet arrival interval and/or statistical value of packet size
(For example, a maximum value, a minimum value, an average value, a standard deviation, or the like)

[NW Control Parameter] Packet transmission interval

### Example 3 (Example of Control of Video Traffic)

[NW State] Throughput and/or packet arrival interval

[NW Control Parameter] Priority and/or band

The control apparatus 100 (the first adjusting means 110 and the second adjusting means 120) may adjust a single network control parameter, or may adjust a plurality of network control parameters.

Note that the above describes an example in which the reward in the reinforcement learning is the same as the network state (in other words, the state of the environment in the reinforcement learning). However, the reward and the network state according to the first example embodiment are not limited to the example described above. The reward and the network state (in other words, the state of the environment in the reinforcement learning) in the reinforcement learning may be different from each other.

The above describes an example in which the reward in the parameter determining method (gradient method) is the same as the reward in the reinforcement learning. However, the reward according to the first example embodiment is not limited to the example described above. The reward in the parameter determining method and the reward in the reinforcement learning may be different from each other.

(2) Second Example Alteration

The above describes an example in which the parameter determining method is the gradient method. However, the parameter determining method according to the first example embodiment is not limited to the example described above.

In the second example alteration of the first example embodiment, for example, the parameter determining method may be another parameter determining method without random determination of the network control parameter.

For example, the parameter determining method may be another parameter determining method of iteratively determining the network control parameter in order to find a value of the network control parameter that minimizes the difference between the target value and the actual value of the reward for determination of the network control parameter.

(3) Third Example Alteration

The above describes an example in which the parameter determining method is the gradient method. However, the parameter determining method according to the first example embodiment is not limited to the example described above.

Parameter Determining Method

In the third example alteration of the first example embodiment, the parameter determining method may be a method of determining the network control parameter based on previous results of adjustment of the network control parameter using the reinforcement learning.

More specifically, the parameter determining method may be a method of determining the network control parameter so that the network control parameter becomes a statistical value of the network control parameter adjusted by using the reinforcement learning. In other words, the parameter determining method may be a statistical value of a possible value of the network control parameter in the reinforcement learning. The statistical value may be an average value, a median, or a mode.

In this manner, for example, the network control parameter can get closer to the optimal value without iteratively determining the network control parameter.

Condition of Operation

There may be a plurality of reinforcement learning based controllers selectively used for adjustment of the network control parameter. The reinforcement learning may be reinforcement learning performed in one reinforcement learning based controller (hereinafter referred to as a “first reinforcement learning based controller”) out of the plurality of reinforcement learning based controllers.

The reinforcement learning based controller actually used for adjustment of the network control parameter may be selected out of the plurality of reinforcement learning based controllers according to a congestion state of the communication network 10. For example, the plurality of reinforcement learning based controllers may correspond to a plurality of congestion levels. In other words, one reinforcement learning based controller may correspond to one congestion level. The network control parameter suitable for the network state is different for each congestion level, and thus by selecting the reinforcement learning based controller for each congestion level, reinforcement learning for each congestion level can be performed. Thus, communication control suitable for the communication environment can be performed.

The reinforcement learning based controller used for adjustment of the network control parameter may be switched to the first reinforcement learning based controller from another reinforcement learning based controller (hereinafter referred to as a “second reinforcement learning based controller”) out of the plurality of reinforcement learning based controllers. In this case, the control apparatus 100 (first adjusting means 110) may adjust the network control parameter by using the parameter determining method. The control apparatus 100 (second adjusting means 120) may adjust the network control parameter by using the reinforcement learning after adjusting the network control parameter using the parameter determining method.

In this manner, for example, the reinforcement learning based controller is switched (in other words, reinforcement learning is switched), and as a result, even if the network control parameter significantly deviates from the value optimal for the network state, the network control parameter can be caused to further promptly get closer to the optimal value.

Flow of Processing

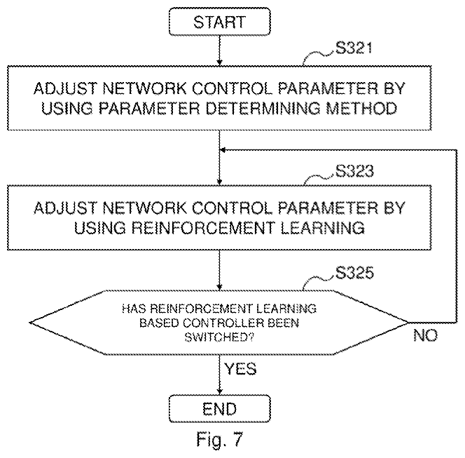

FIG. 7 is a flowchart for illustrating an example of a general flow of parameter adjustment processing according to the third example alteration of the first example embodiment.

The parameter adjustment processing is started when the reinforcement learning based controller used for adjustment of the network control parameter is switched from the second reinforcement learning based controller to the first reinforcement learning based controller.

The control apparatus 100 (first adjusting means 110) adjusts the network control parameter by using the parameter determining method (specifically, the method of determining the network control parameter based on previous results of adjustment of the network control parameter using reinforcement learning) (S321).

The control apparatus 100 (second adjusting means 120) adjusts the network control parameter by using reinforcement learning (S323).

When the reinforcement learning based controller used for adjustment of the network control parameter is switched from the first reinforcement learning based controller to a third reinforcement learning based controller (S325—Yes), the processing ends. Note that, subsequently, the parameter adjustment processing illustrated in FIG. 7 may also be performed regarding the third reinforcement learning based controller.

When the reinforcement learning based controller used for adjustment of the network control parameter is not switched (S325—NO), the control apparatus 100 (second adjusting means 120) continues to adjust the network control parameter by using the reinforcement learning (S323).

(4) Fourth Example Alteration

As described above, for example, in order to adjust the network control parameter, one parameter determining method is used. However, the first example embodiment is not limited to the example described above.

Selection from Plurality of Parameter Determining Methods

In the fourth example alteration of the first example embodiment, the control apparatus 100 (first adjusting means 110) may select a parameter determining method out of a plurality of parameter determining methods, and adjust the parameter by using the parameter determining method.

The plurality of parameter determining methods may include the gradient method (in other words, the parameter determining method in the main example of the first example embodiment). The plurality of parameter determining methods may include the method of determining the network control parameter based on previous results of adjustment of the network control parameter using the reinforcement learning (in other words, the parameter determining method in the third example alteration of the first example embodiment).

Selection Based on Degree of Maturity of Learning in Reinforcement Learning

The control apparatus 100 (first adjusting means 110) may select the parameter determining method out of the plurality of parameter determining methods, based on a degree of maturity of learning in the reinforcement learning.

For example, when learning is not mature in the reinforcement learning, the control apparatus 100 (first adjusting means 110) may select the gradient method.

For example, when learning is mature in the reinforcement learning, the control apparatus 100 (first adjusting means 110) may select the method of determining the network control parameter based on the previous results.

For example, when the reward is constant in time series (for example, within a certain range) in the reinforcement learning, it may be determined that learning is mature in the reinforcement learning. In addition or alternatively, when the reward reaches close to its upper limit in the reinforcement learning (for example, the difference between the reward and the upper limit is less than a threshold), it may be determined that learning is mature in the reinforcement learning. The upper limit may be obtained from a history of previous learning.

In this manner, for example, when learning in reinforcement learning is mature, the network control parameter can be efficiently adjusted based on a history, and when the learning is not mature, the network control parameter can be securely adjusted by using the gradient method.

Condition of Operation

Description regarding the condition of the operation in the fourth example alteration is the same as the description regarding the operation in the third example alteration. Thus, overlapping description will be omitted here.

Flow of Processing

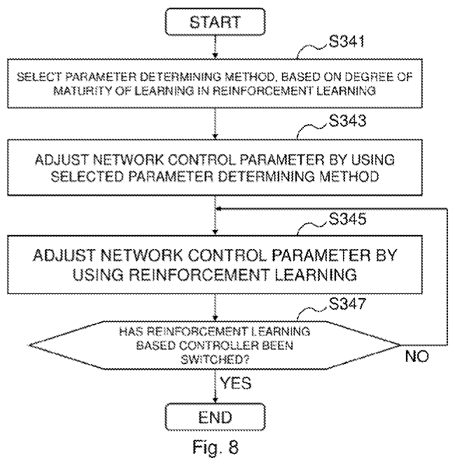

FIG. 8 is a flowchart for illustrating an example of a general flow of parameter adjustment processing according to the fourth example alteration of the first example embodiment.

The parameter adjustment processing is started when the reinforcement learning based controller used for adjustment of the network control parameter is switched from the second reinforcement learning based controller to the first reinforcement learning based controller.

The control apparatus 100 (first adjusting means 110) selects a parameter determining method out of a plurality of parameter determining methods, based on a degree of maturity of learning in reinforcement learning (S341).

The control apparatus 100 (first adjusting means 110) adjusts the network control parameter by using the selected parameter determining method (S343).

The control apparatus 100 (second adjusting means 120) adjusts the network control parameter by using the reinforcement learning (S345).

When the reinforcement learning based controller used for adjustment of the network control parameter is switched from the first reinforcement learning based controller to the third reinforcement learning based controller (S347—Yes), the processing ends. Note that, subsequently, the parameter adjustment processing illustrated in FIG. 8 may also be performed regarding the third reinforcement learning based controller.

When the reinforcement learning based controller used for adjustment of the network control parameter is not switched (S347—NO), the control apparatus 100 (second adjusting means 120) continues to adjust the network control parameter by using the reinforcement learning (S345).

(5) Fifth Example Alteration

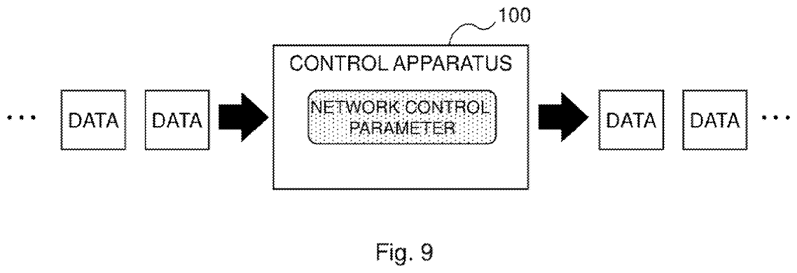

As described above, for example, the control apparatus 100 is a network device (for example, a proxy server, a gateway, a router, a switch, and/or the like) that transfers data in the communication network 10 (see FIG. 9). As described above, for example, the control apparatus 100 (communication processing means 130) transfers data (for example, packets) according to the network control parameter adjusted by the control apparatus 100 (the first adjusting means 110 and the second adjusting means 120) (see FIG. 9). However, the control apparatus 100 according to the first example embodiment is not limited to the example described above.

### First Example

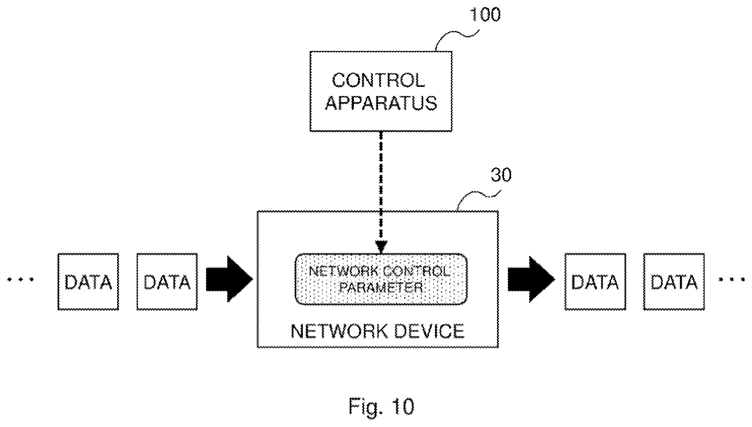

In the fifth example alteration of the first example embodiment, as a first example, as illustrated in FIG. 10, the control apparatus 100 may be an apparatus (for example, a network controller) that controls a network device 30 that transfers data in the communication network 10, instead of a network device itself that transfers data in the communication network 10.

In particular, the network control parameter may be a parameter configured in the network device 30, and the control apparatus 100 (the first adjusting means 110 and the second adjusting means 120) may adjust the network control parameter configured in the network device 30. Specifically, for example, the control apparatus 100 (the first adjusting means 110 and the second adjusting means 120) may transmit parameter information (for example, a command for instructing a change of the network control parameter) for adjusting the network control parameter to the network device 30. The network device 30 may configure the network control parameter, based on the parameter information, and may transfer data (for example, packets) according to the network control parameter.

In addition, the network state may be a state observed in the network device 30. For example, the control apparatus 100 may receive information indicating the state observed in the network device 30 from the network device 30.

### Second Example

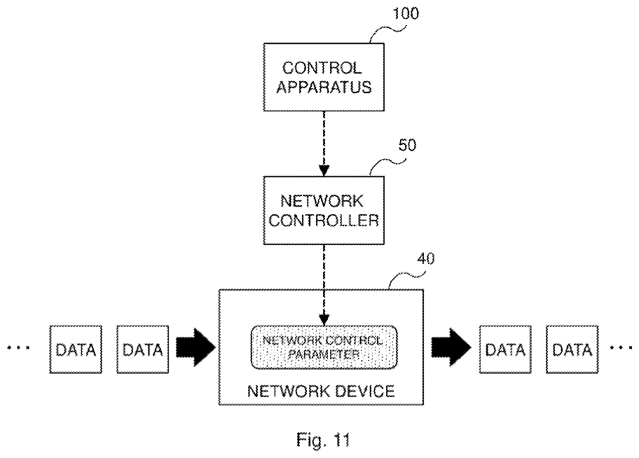

As a second example, as illustrated in FIG. 11, a network controller 50 may control a network device 40 that transfers data in the communication network 10, and the control apparatus 100 may be an apparatus that controls or assists the network controller 50.

In particular, the network control parameter may be a parameter configured in the network device 40, and the control apparatus 100 (the first adjusting means 110 and the second adjusting means 120) may adjust the network control parameter configured in the network device 40. Specifically, for example, the control apparatus 100 (the first adjusting means 110 and the second adjusting means 120) may transmit first parameter information (for example, a command for instructing a change of the network control parameter or assist information reporting a change of the network control parameter) for adjusting the network control parameter to the network controller 50. In addition, the network controller 50 may transmit second parameter information (for example, a command for instructing a change of the network control parameter) for adjusting the network control parameter to the network device 40, based on the first parameter information. The network device 40 may configure the network control parameter, based on the second parameter information, and may transfer data (for example, packets) according to the network control parameter.

In addition, the network state may be a state observed in the network device 40. For example, the control apparatus 100 may receive information indicating the state observed in the network device 40 from the network device 40 or the network controller 50.

### Third Example

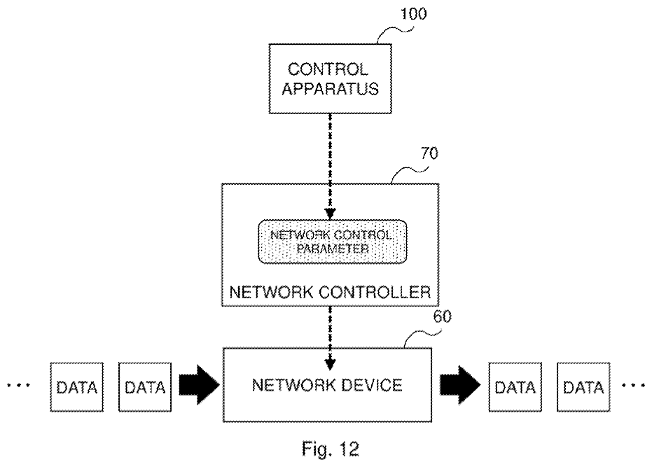

As a third example, as illustrated in FIG. 12, a network controller 70 may control a network device 60 that transfers data in the communication network 10, and the control apparatus 100 may be an apparatus that controls the network controller 70.

In particular, the network control parameter may be a parameter configured in the network controller 70, and the control apparatus 100 (the first adjusting means 110 and the second adjusting means 120) may adjust the network control parameter configured in the network controller 70. Specifically, for example, the control apparatus 100 (the first adjusting means 110 and the second adjusting means 120) may transmit parameter information (for example, a command for instructing a change of the network control parameter) for adjusting the network control parameter to the network controller 70. In addition, the network controller 70 may configure the network control parameter based on the parameter information, and control the network device 60 according to the network control parameter. The network device 40 may transfer data (for example, packets) according to control by the network controller 70.

In addition, the network state may be a state observed in the network device 60. For example, the control apparatus 100 may receive information indicating the state observed in the network device 60 from the network device 60 or the network controller 70.

(6) Sixth Example Alteration

As described above, for example, the control apparatus 100 includes the first adjusting means 110, the second adjusting means 120, and the communication processing means 130. However, the control apparatus 100 according to the first example embodiment is not limited to the example described above.

In the sixth example alteration of the first example embodiment, for example, the control apparatus 100 includes the first adjusting means 110, but the control apparatus 100 need not include the second adjusting means 120 and another apparatus may include the second adjusting means 120. Alternatively, the control apparatus 100 includes the second adjusting means 120, but the control apparatus 100 need not include the first adjusting means 110 and another apparatus may include the first adjusting means 110.

In the sixth example alteration of the first example embodiment, for example, the communication processing means 130 that transfers data (for example, packets) may be included in another apparatus instead of being included in the control apparatus 100. For example, in a case as in the fifth example alteration, the communication processing means 130 may be included in a network device instead of being included in the control apparatus 100.

### 3. Second Example Embodiment

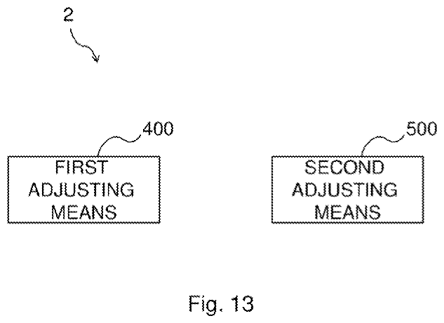

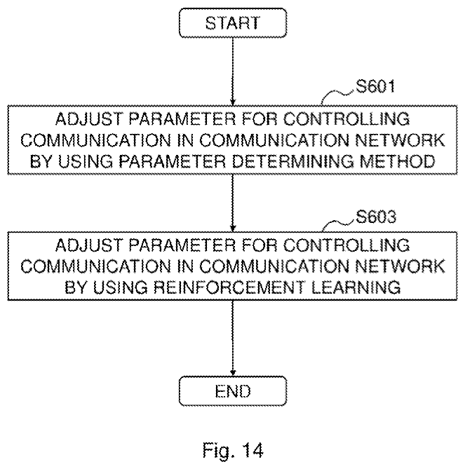

Next, with reference to FIG. 13 and FIG. 14, a second example embodiment of the present disclosure will be described. The above-described first example embodiment is a concrete example embodiment, whereas the second example embodiment is a more generalized example embodiment.

FIG. 13 illustrates an example of a schematic configuration of a system 2 according to the second example embodiment. With reference to FIG. 13, the system 2 includes a first adjusting means 400 and a second adjusting means 500.

FIG. 14 is a flowchart for illustrating an example of a general flow of parameter adjustment processing according to the second example embodiment.

The first adjusting means 400 adjusts the parameter for controlling communication in the communication network by using the parameter determining method (S601).

The second adjusting means 500 adjusts the parameter by using reinforcement learning (S603).

Description regarding the parameter (specifically, the network control parameter), the reinforcement learning, the parameter determining method, and the condition of operation is, for example, the same as the description regarding those of the first example embodiment. In addition, description of example alterations of the second example embodiment is the same as the description regarding the example alterations of the first example embodiment except for differences of the reference signs. Thus, overlapping description will be omitted here.

As described above, the parameter is adjusted. In this manner, for example, communication control can be caused to promptly comply with the communication environment.

Descriptions have been given above of the example embodiments of the present disclosure. However, the present disclosure is not limited to these example embodiments. It should be understood by those of ordinary skill in the art that these example embodiments are merely examples and that various alterations are possible without departing from the scope and the spirit of the present disclosure.

For example, the steps in the processing described in the Specification may not necessarily be executed in time series in the order described in the flowcharts. For example, the steps in the processing may be executed in order different from that described in the flowcharts or may be executed in parallel. Some of the steps in the processing may be deleted, or more steps may be added to the processing.

Moreover, a method including processing of the constituent elements of the system or the control apparatus described in the Specification may be provided, and programs for causing a processor to execute the processing of the constituent elements may be provided. Moreover, a non-transitory computer readable recording medium (non-transitory computer readable recording media) having recorded thereon the programs may be provided. It is apparent that such methods, programs, and non-transitory computer readable recording media are also included in the present disclosure.

The whole or part of the example embodiments disclosed above can be described as, but not limited to, the following supplementary notes.

### (Supplementary Note 1)

A system comprising:

a first adjusting means for adjusting a parameter for controlling communication in a communication network by using a parameter determining method; and

a second adjusting means for adjusting the parameter by using reinforcement learning, after adjusting the parameter using the parameter determining method.

### (Supplementary Note 2)

The system according to supplementary note 1, wherein the second adjusting means adjusts the parameter, based on a state of the communication network by using the reinforcement learning.

### (Supplementary Note 3)

The system according to supplementary note 1 or 2, wherein in the reinforcement learning, the second adjusting means applies a state of the communication network as a state of an environment and applies a change of the parameter as an action selected according to the state of the environment, to adjust the parameter by using the reinforcement learning.

### (Supplementary Note 4)

The system according to supplementary note 3, wherein

in the reinforcement learning, the second adjusting means selects a random change of the parameter as exploration, to adjust the parameter, and selects an optimal change of the parameter in terms of learning results as exploitation, to adjust the parameter, and

the first adjusting means adjusts the parameter without randomly determining the parameter in the parameter determining method.

### (Supplementary Note 5)

The system according to any one of supplementary notes 1 to 4, wherein the parameter determining method is a gradient method.

### (Supplementary Note 6)

The system according to any one of supplementary notes 1 to 5, wherein the first adjusting means adjusts the parameter by iteratively determining the parameter by using the parameter determining method to find a value of the parameter that minimizes a difference between a target value and an actual value of a reward for determination of the parameter.

### (Supplementary Note 7)

The system according to supplementary note 6, wherein the reward is the same as a reward in the reinforcement learning.

### (Supplementary Note 8)

The system according to supplementary note 6 or 7, wherein

the first adjusting means ends adjustment of the parameter using the parameter determining method when the difference is less than a predetermined threshold, and

the second adjusting means adjusts the parameter by using the reinforcement learning when adjustment of the parameter using the parameter determining method ends.

### (Supplementary Note 9)

The system according to any one of supplementary notes 6 to 8, wherein

the first adjusting means ends adjustment of the parameter using the parameter determining method when the number of times of determination of the parameter reaches a predetermined number of times, and

the second adjusting means adjusts the parameter by using the reinforcement learning when adjustment of the parameter using the parameter determining method ends.

### (Supplementary Note 10)

The system according to any one of supplementary notes 1 to 4, wherein the parameter determining method is a method of determining the parameter, based on previous results of adjustment of the parameter using the reinforcement learning.

### (Supplementary Note 11)

The system according to supplementary note 10, wherein the parameter determining method is a method of determining the parameter so that the parameter is a statistical value of the parameter adjusted by using the reinforcement learning.

### (Supplementary Note 12)

The system according to any one of supplementary notes 1 to 4, wherein the first adjusting means selects the parameter determining method out of a plurality of parameter determining methods, and adjusts the parameter by using the parameter determining method.

### (Supplementary Note 13)

The system according to supplementary note 12, wherein the first adjusting means selects the parameter determining method out of the plurality of parameter determining methods, based on a degree of maturity of learning in the reinforcement learning.

### (Supplementary Note 14)

The system according to supplementary note 12 or 13, wherein

the plurality of parameter determining methods include

a gradient method, and

a method of determining the parameter, based on previous results of adjustment of the parameter using the reinforcement learning.

### (Supplementary Note 15)

The system according to supplementary note 14, wherein the parameter determining method is the gradient method when learning is not mature in the reinforcement learning, and is the method of determining the parameter based on the previous results when learning is mature in the reinforcement learning.

### (Supplementary Note 16)

The system according to any one of supplementary notes 1 to 9, wherein when a predetermined condition regarding a change of a state of the communication network is satisfied, the first adjusting means adjusts the parameter by using the parameter determining method, and the second adjusting means adjusts the parameter by using the reinforcement learning after adjusting the parameter using the parameter determining method.

### (Supplementary Note 17)

The system according to supplementary note 16, wherein the predetermined condition is that a change amount of the state of the communication network in a certain time period exceeds a predetermined threshold.

### (Supplementary Note 18)

The system according to any one of supplementary notes 1 to 17, wherein

the reinforcement learning is reinforcement learning performed in one reinforcement learning based controller out of a plurality of reinforcement learning based controllers selectively used for adjustment of the parameter, and

when a reinforcement learning based controller used for adjustment of the parameter is switched to the one reinforcement learning based controller in which the reinforcement learning is performed from another reinforcement learning based controller out of the plurality of reinforcement learning based controllers, the first adjusting means adjusts the parameter by using the parameter determining method, and the second adjusting means adjusts the parameter by using the reinforcement learning after adjusting the parameter using the parameter determining method.

### (Supplementary Note 19)

A method comprising:

adjusting a parameter for controlling communication in a communication network by using a parameter determining method; and

adjusting the parameter by using reinforcement learning after adjusting the parameter using the parameter determining method.

### (Supplementary Note 20)

The method according to supplementary note 19, wherein the parameter is adjusted based on a state of the communication network by using the reinforcement learning.

### (Supplementary Note 21)

The method according to supplementary note 19 or 20, wherein in the reinforcement learning, a state of the communication network is applied as a state of an environment and a change of the parameter is applied as an action selected according to the state of the environment, to adjust the parameter by using the reinforcement learning.

### (Supplementary Note 22)

The method according to supplementary note 21, wherein

in the reinforcement learning, a random change of the parameter is selected as exploration to adjust the parameter, and an optimal change of the parameter is selected in terms of learning results as exploitation to adjust the parameter, and

the parameter is adjusted without randomly determining the parameter in the parameter determining method.

### (Supplementary Note 23)

The method according to any one of supplementary notes 19 to 22, wherein the parameter determining method is a gradient method.

### (Supplementary Note 24)

The method according to any one of supplementary notes 19 to 23, wherein the parameter is adjusted by iteratively determining the parameter by using the parameter determining method to find a value of the parameter that minimizes a difference between a target value and an actual value of a reward for determination of the parameter.

### (Supplementary Note 25)

The method according to supplementary note 24, wherein the reward is the same as a reward in the reinforcement learning.

### (Supplementary Note 26)

The method according to supplementary note 24 or 25, wherein

adjustment of the parameter using the parameter determining method ends when the difference is less than a predetermined threshold, and

the parameter is adjusted by using the reinforcement learning when adjustment of the parameter using the parameter determining method ends.

### (Supplementary Note 27)

The method according to any one of supplementary notes 24 to 26, wherein

adjustment of the parameter using the parameter determining method ends when the number of times of determination of the parameter reaches a predetermined number of times, and

the parameter is adjusted by using the reinforcement learning when adjustment of the parameter using the parameter determining method ends.

### (Supplementary Note 28)

The method according to any one of supplementary notes 19 to 22, wherein the parameter determining method is a method of determining the parameter, based on previous results of adjustment of the parameter using the reinforcement learning.

### (Supplementary Note 29)

The method according to supplementary note 28, wherein the parameter determining method is a method of determining the parameter so that the parameter is a statistical value of the parameter adjusted by using the reinforcement learning.

### (Supplementary Note 30)

The method according to any one of supplementary notes 19 to 22, further comprising:

selecting the parameter determining method out of a plurality of parameter determining methods.

### (Supplementary Note 31)

The method according to supplementary note 30, wherein the parameter determining method is selected out of the plurality of parameter determining methods, based on a degree of maturity of learning in the reinforcement learning.

### (Supplementary Note 32)

The method according to supplementary note 30 or 31, wherein

the plurality of parameter determining methods include a gradient method, and

a method of determining the parameter, based on previous results of adjustment of the parameter using the reinforcement learning.

### (Supplementary Note 33)

The method according to supplementary note 32, wherein the parameter determining method is the gradient method when learning is not mature in the reinforcement learning, and is the method of determining the parameter based on the previous results when learning is mature in the reinforcement learning.

### (Supplementary Note 34)

The method according to any one of supplementary notes 19 to 27, wherein when a predetermined condition regarding a change of a state of the communication network is satisfied, the parameter is adjusted by using the parameter determining method, and the parameter is adjusted by using the reinforcement learning after adjusting the parameter using the parameter determining method.

### (Supplementary Note 35)

The method according to supplementary note 34, wherein the predetermined condition is that a change amount of the state of the communication network in a certain time period exceeds a predetermined threshold.

### (Supplementary Note 36)

The method according to any one of supplementary notes 19 to 35, wherein

the reinforcement learning is reinforcement learning performed in one reinforcement learning based controller out of a plurality of reinforcement learning based controllers selectively used for adjustment of the parameter, and

when a reinforcement learning based controller used for adjustment of the parameter is switched to the one reinforcement learning based controller in which the reinforcement learning is performed from another reinforcement learning based controller out of the plurality of reinforcement learning based controllers, the parameter is adjusted by using the parameter determining method, and the parameter is adjusted by using the reinforcement learning after the parameter is adjusted using the parameter determining method.

### (Supplementary Note 37)

A control apparatus comprising:

a first adjusting means for adjusting a parameter for controlling communication in a communication network by using a parameter determining method; and

a second adjusting means for adjusting the parameter by using reinforcement learning, after adjusting the parameter using the parameter determining method.

### (Supplementary Note 38)

The control apparatus according to supplementary note 37, wherein the second adjusting means adjusts the parameter, based on a state of the communication network by using the reinforcement learning.

### (Supplementary Note 39)

The control apparatus according to supplementary note 37 or 38, wherein in the reinforcement learning, the second adjusting means applies a state of the communication network as a state of an environment and applies a change of the parameter as an action selected according to the state of the environment, to adjust the parameter by using the reinforcement learning.

### (Supplementary Note 40)

The control apparatus according to supplementary note 39, wherein

in the reinforcement learning, the second adjusting means selects a random change of the parameter as exploration, to adjust the parameter, and selects an optimal change of the parameter in terms of learning results as exploitation, to adjust the parameter, and

the first adjusting means adjusts the parameter without randomly determining the parameter in the parameter determining method.

### (Supplementary Note 41)

The control apparatus according to any one of supplementary notes 37 to 40, wherein the parameter determining method is a gradient method.

### (Supplementary Note 42)

The control apparatus according to any one of supplementary notes 37 to 41, wherein the first adjusting means adjusts the parameter by iteratively determining the parameter by using the parameter determining method to find a value of the parameter that minimizes a difference between a target value and an actual value of a reward for determination of the parameter.

### (Supplementary Note 43)

The control apparatus according to supplementary note 42, wherein the reward is the same as a reward in the reinforcement learning.

### (Supplementary Note 44)

The control apparatus according to supplementary note 42 or 43, wherein the first adjusting means ends adjustment of the parameter using the parameter determining method when the difference is less than a predetermined threshold, and the second adjusting means adjusts the parameter by using the reinforcement learning when adjustment of the parameter using the parameter determining method ends.

### (Supplementary Note 45)

The control apparatus according to any one of supplementary notes 42 to 44, wherein

the first adjusting means ends adjustment of the parameter using the parameter determining method when the number of times of determination of the parameter reaches a predetermined number of times, and

the second adjusting means adjusts the parameter by using the reinforcement learning when adjustment of the parameter using the parameter determining method ends.

### (Supplementary Note 46)

The control apparatus according to any one of supplementary notes 37 to 40, wherein the parameter determining method is a method of determining the parameter, based on previous results of adjustment of the parameter using the reinforcement learning.

### (Supplementary Note 47)

The control apparatus according to supplementary note 46, wherein the parameter determining method is a method of determining the parameter so that the parameter is a statistical value of the parameter adjusted by using the reinforcement learning.

### (Supplementary Note 48)

The control apparatus according to any one of supplementary notes 37 to 40, wherein the first adjusting means selects the parameter determining method out of a plurality of parameter determining methods, and adjusts the parameter by using the parameter determining method.

### (Supplementary Note 49)

The control apparatus according to supplementary note 48, wherein the first adjusting means selects the parameter determining method out of the plurality of parameter determining methods, based on a degree of maturity of learning in the reinforcement learning.

### (Supplementary Note 50)

The control apparatus according to supplementary note 48 or 49, wherein

the plurality of parameter determining methods include a gradient method, and

a method of determining the parameter, based on previous results of adjustment of the parameter using the reinforcement learning.

### (Supplementary Note 51)

The control apparatus according to supplementary note 50, wherein the parameter determining method is the gradient method when learning is not mature in the reinforcement learning, and is the method of determining the parameter based on the previous results when learning is mature in the reinforcement learning.

### (Supplementary Note 52)

The control apparatus according to any one of supplementary notes 37 to 45, wherein when a predetermined condition regarding a change of a state of the communication network is satisfied, the first adjusting means adjusts the parameter by using the parameter determining method, and the second adjusting means adjusts the parameter by using the reinforcement learning after adjusting the parameter using the parameter determining method.

### (Supplementary Note 53)

The control apparatus according to supplementary note 52, wherein the predetermined condition is that a change amount of the state of the communication network in a certain time period exceeds a predetermined threshold.

### (Supplementary Note 54)

The control apparatus according to any one of supplementary notes 37 to 53, wherein

the reinforcement learning is reinforcement learning performed in one reinforcement learning based controller out of a plurality of reinforcement learning based controllers selectively used for adjustment of the parameter, and

when a reinforcement learning based controller used for adjustment of the parameter is switched to the one reinforcement learning based controller in which the reinforcement learning is performed from another reinforcement learning based controller out of the plurality of reinforcement learning based controllers, the first adjusting means adjusts the parameter by using the parameter determining method, and the second adjusting means adjusts the parameter by using the reinforcement learning after adjusting the parameter using the parameter determining method.

### (Supplementary Note 55)

A program that causes a processor to execute:

adjusting a parameter for controlling communication in a communication network by using a parameter determining method; and

adjusting the parameter by using reinforcement learning after adjusting the parameter using the parameter determining method.

### (Supplementary Note 56)

A non-transitory computer readable recording medium recording a program that causes a processor to execute:

adjusting a parameter for controlling communication in a communication network by using a parameter determining method; and

adjusting the parameter by using reinforcement learning after adjusting the parameter using the parameter determining method.

### REFERENCE SIGNS LIST

| | |
|---|---|
| 1, 2 | System |
| 10 | Communication Network |
| 100 | Control Apparatus |
| 110, 400 | First Adjusting Means |
| 120, 500 | Second Adjusting Means |

What is claimed is:

1. A system comprising:
one or more apparatuses each including a memory storing instructions and one or more processors configured to execute the instructions, wherein
the one or more apparatuses are configured to:
adjust a parameter for controlling communication in a communication network by using a parameter determining method; and
adjust the parameter by using reinforcement learning, after adjusting the parameter using the parameter determining method.

2. The system according to claim 1, wherein
the one or more apparatuses are configured to adjust the parameter by iteratively determining the parameter by using the parameter determining method to find a value of the parameter that minimizes a difference between a target value and an actual value of a reward for determination of the parameter.

3. The system according to claim 2, wherein
the one or more apparatuses are configured to:
end adjustment of the parameter using the parameter determining method when the difference is less than a predetermined threshold, and
adjust the parameter by using the reinforcement learning when adjustment of the parameter using the parameter determining method ends.

4. The system according to claim 1, wherein
the one or more apparatuses are configured to select the parameter determining method out of a plurality of parameter determining methods, and adjusts the parameter by using the parameter determining method.

5. The system according to claim 4, wherein
the one or more apparatuses are configured to select the parameter determining method out of the plurality of parameter determining methods, based on a degree of maturity of learning in the reinforcement learning.

6. The system according to claim 4, wherein
the plurality of parameter determining methods include
a gradient method, and
a method of determining the parameter, based on previous results of adjustment of the parameter using the reinforcement learning.

7. A method comprising:
adjusting a parameter for controlling communication in a communication network by using a parameter determining method; and
adjusting the parameter by using reinforcement learning after adjusting the parameter using the parameter determining method.

8. The method according to claim 7, wherein
the parameter is adjusted by iteratively determining the parameter by using the parameter determining method to find a value of the parameter that minimizes a difference between a target value and an actual value of a reward for determination of the parameter.

9. The method according to claim 8, wherein
adjustment of the parameter using the parameter determining method ends when the difference is less than a predetermined threshold, and
the parameter is adjusted by using the reinforcement learning when adjustment of the parameter using the parameter determining method ends.

10. The method according to claim 7, further comprising:
selecting the parameter determining method out of a plurality of parameter determining methods.

11. The method according to claim 10, wherein
the parameter determining method is selected out of the plurality of parameter determining methods, based on a degree of maturity of learning in the reinforcement learning.

12. The method according to claim 10, wherein
the plurality of parameter determining methods include
a gradient method, and
a method of determining the parameter, based on previous results of adjustment of the parameter using the reinforcement learning.

13. A control apparatus comprising:
a memory storing instructions; and
one or more processors configured to execute the instructions to:
adjust a parameter for controlling communication in a communication network by using a parameter determining method; and
adjust the parameter by using reinforcement learning, after adjusting the parameter using the parameter determining method.

14. The control apparatus according to claim 13, wherein
the one or more processors are configured to execute the instructions to adjust the parameter by iteratively determining the parameter by using the parameter determining method to find a value of the parameter that minimizes a difference between a target value and an actual value of a reward for determination of the parameter.

15. The control apparatus according to claim 14, wherein
the one or more processors are configured to execute the instructions to:
end adjustment of the parameter using the parameter determining method when the difference is less than a predetermined threshold, and
adjust the parameter by using the reinforcement learning when adjustment of the parameter using the parameter determining method ends.

16. The control apparatus according to claim 13, wherein
the one or more processors are configured to execute the instructions to select the parameter determining method out of a plurality of parameter determining methods, and adjusts the parameter by using the parameter determining method.

17. The control apparatus according to claim 16, wherein
the one or more processors are configured to execute the instructions to select the parameter determining method out of the plurality of parameter determining methods, based on a degree of maturity of learning in the reinforcement learning.

18. The control apparatus according to claim 16, wherein
the plurality of parameter determining methods include
a gradient method, and
a method of determining the parameter, based on previous results of adjustment of the parameter using the reinforcement learning.
